(19) United States
(12) Patent Application Publication
(10) Pub. No.: US 2009/0246483 A1
(43) Pub. Date: Oct. 1, 2009

(54) MATTE RESIN FILM

(75) Inventor: Norio SUGIMURA, Niihama-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/414,314

(22) Filed: Mar. 30, 2009

(30) Foreign Application Priority Data
Mar. 31, 2008 (JP) 2008-090679

(51) Int. Cl. B32B 3/10; B32B 27/30; B32B 5/16; B32B 27/08

(52) U.S. Cl. 428/195.1; 428/500; 428/323; 428/515; 428/220

(57) ABSTRACT

A matte resin film comprising a resin film substrate and a matte layer formed on at least one surface of the substrate, wherein a 60 degree specular gloss Gs on the surface of the matte layer is 5% to 100%, a haze H satisfies the equation: H(%)<1400/Gs(%), and a 85 degree specular gloss Gs′ on the surface of the matte layer is smaller than Gs, which exhibits an excellent matte effect even when a pattern is viewed at any viewing angle.

### FIELD OF THE INVENTION

The present invention relates to a matte resin film having a matte layer formed on the surface of a resin film substrate. The present invention also relates to a marking film comprising a matte resin film. Furthermore, the present invention relates to a multilayer film or sheet comprising the matte resin film laminated on other film or sheet and a laminated molded article comprising a matte resin film or a multilayer film or sheet integrally laminated on the surface of a molded article comprising a thermoplastic resin.

### BACKGROUND ART

Hitherto, a plastic plate such as an acrylic resin plate or a polycarbonate resin plate is generally used as a substrate which is matted or grained. For example, the surface of a substrate is matted or grained by thermoforming, and the substrate is used as a decorative molded article. In these years, as a method for producing such a highly decorative molded article, a film-lamination method such as a simultaneous injection molding-lamination method has been frequently employed, and increasingly desired for the production of matted acrylic resin films.

As a matte resin film, a film produced by transferring a matte pattern onto the surface of the film or a film produced by kneading a matting agent in a resin is known (see JP-A-3-237134 and JP-A-10-237261). Also, JP-A-2003-211598 proposes a matte resin film having, on its surface, a matte layer (a delustered layer) of a thermosetting resin or a photocurable resin by compounding inorganic fine particles in the resin.

Matte resin films are often employed in the simultaneous injection molding-lamination method or the like, in which patterns are printed on a surface of the matte resin film opposite to the matte surface in order to enhance the designability of a molded article on which the matte resin film is laminated. However, the conventional matte resin films have a drawback such that a pattern tends to be seen cloudy and unclear when it is viewed from the side of the matte surface. In addition, depending on reflective angles of light, particularly in the case of a small viewing angle in relation to the matte surface, a matting effect of the matte surface is not sufficient, resulting in a problem of causing shininess of the reflected light.

### SUMMARY OF THE INVENTION

An object of the present invention is to provide a matte resin film which enables a pattern to be clearly seen from the side of a matte surface when the pattern is printed on a surface of the matte resin film opposite to the matte surface, and exhibits an excellent matting effect even when the pattern is viewed at any angle.

As the result of extensive studies, the inventor of the present application has found that a matte resin film having a matte layer formed on the surface of a resin film substrate and having a specific gloss and a specific haze is suitable for achieving the above purpose. The present invention has been completed based on such a finding.

Accordingly, the present invention provides a matte resin film comprising a resin film substrate and a matte layer formed on at least one surface of the substrate, wherein a 60 degree specular gloss Gs on the surface of the matte layer is 14 to 60%, a haze H satisfies the following equation:

H(%)<1400/Gs(%)

and a 85 degree specular gloss Gs′ on the surface of the matte layer is smaller than Gs.

In the matte resin film of the present invention, designability may be imparted to the film, for example, by forming a matte layer on one surface of a film substrate and printing a pattern on the other surface of the matte layer. In this case, if a pressure-sensitive adhesive layer is formed on the surface on which the pattern is printed, the matte resin film can be used as a marking film. Furthermore, a multilayer film or sheet can be formed by laminating other film or sheet on the surface of the matte resin film opposite to the matte layer where the matte layer of the matte resin film serves as a front surface. Moreover, a laminate molded article with excellent designability can be produced by integrally laminating the matte resin film or the multilayer film or sheet oil a thermoplastic resin molded article in such a manner that the matte layer serves as a front surface.

A laminate molded article with good designability can be obtained by using the matte resin film of the present invention, since a pattern can be clearly seen from the side of the matte surface when it is printed on the surface of the matte resin film opposite to the matte surface, and an excellent matting effect can be attained even when the pattern is viewed at any angle.

### BRIEF DESCRIPTION OF THE DRAWING

FIG. 1 is a schematic cross sectional view showing one example of a layer structure of a matte resin film according to the present invention.

### DETAILED DESCRIPTION OF THE INVENTION

The matte resin film of the present invention has a matte layer formed on at least one surface of a resin film substrate, and the 60 degree specular gloss Gs on the surface of the matte layer is from 5 to 100%, preferably from 14% to 60%, more preferably from 16% to 50%, and still more preferably from 20% to 40%. If the Gs is lower than 5%, the matting effect becomes so high that it is difficult to maintain the transparency of the film, so that the film tends to be seen dull white. Thus, a pattern which is viewed from the side of the matte surface tends to be seen cloudy and unclear, when it is printed on the surface of the matte resin film opposite to the matte surface. If the Gs exceeds 100%, the matting effect is not sufficient. In addition, the matte resin film of the present invention has a haze H satisfying the equation: H(%)<1400/Gs(%), preferably the equation: H(%)<1300/Gs(%), and more preferably the equation: H(%)<1200/Gs(%). When the H and the Gs satisfy the above equation, a matte resin film with excellent transparency is formed and a pattern which is printed on the surface of the matte resin film opposite to the matte surface is clearly seen when it is viewed from the side of the matte surface.

In addition, with the matte resin film of the present invention, the 85 degree specular gloss Gs′ on the surface of the matte layer is smaller than the 60 degree specular gloss Gs. When the Gs′ is smaller than the Gs, a sufficient matting effect for practical use is attained whenever the film is viewed at any angle. If the Gs′ is larger than the Gs, shininess tends to appear due to the insufficient diffusion of a reflected light in a case where an angle between the matte surface and a direction for observing the reflected light is small.

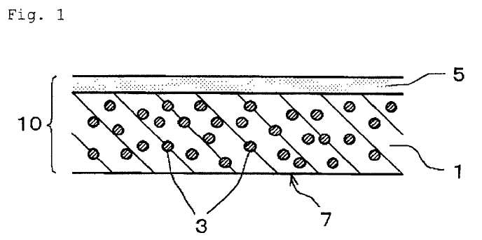

A preferred example of the layer structure of the matte resin film of the present invention is shown in FIG. 1 as a schematic cross-sectional view.

In this example, a matte layer 5 is formed on one surface of a film substrate 1. Also, in this example, the film substrate 1 comprises a resin composition containing rubber particles 3 dispersed in a matrix resin. The matte resin film of the present invention which satisfies the predetermined optical properties described above may be produced by adjusting the composition and thickness of each of the film substrate 1 and the matte layer 5.

Examples of the resin composing the film substrate 1 include acrylic resins, styrene resins, vinyl chloride resins, olefin resins, polyurethane resins, polyester resins, polycarbonate resins, and the like. In view of transparency and weather resistance, acrylic resins are preferably used, and particularly, a resin composition containing a polymer comprising an alkyl methacrylate as a matrix resin and acrylic rubber particles dispersed in the matrix resin (an impact resistant acrylic resin) is preferably used.

The polymer comprising an alkyl methacrylate is prepared by polymerizing a monomer containing 50% by weight or more of an alkyl methacrylate. Specific examples of such a polymer include homo-poly(alkyl methacrylate), i.e., polymers consisting essentially of an alkyl methacrylate, copolymers of two or more alkyl methacrylates, and copolymers of an alkyl methacrylate and a monomer copolymerizable with the alkyl methacrylate such as an acrylate, etc. The alkyl methacrylate may preferably have about 1 to 4 carbon atoms in its alkyl moiety. In particular, methyl methacrylate is preferable. In the case of a copolymer of an alkyl methacrylate and an acrylate, specific examples of the acrylate as the copolymerizable monomer include alkyl acrylates having preferably about 1 to 10 carbon atoms in their alkyl moieties. Specific examples of the alkyl acrylates include methyl acrylate, ethyl acrylate, propyl acrylate, isopropyl acrylate, butyl acrylate, isobutyl acrylate, hexyl acrylate, octyl acrylate, 2-ethylhexyl acrylate, etc.

In the case of a copolymer of an alkyl methacrylate and an alkyl acrylate, a copolymer preferably contains about 50 to 99.5% by weight of alkyl methacrylate units and about 50 to 0.5% by weight of alkyl acrylate units. Furthermore, the copolymer may optionally contain other monomer units as a copolymer component in an amount such that the effects of the present invention are not impaired.

The polymer comprising an alkyl methacrylate preferably has a glass transition temperature of from 60° C. to 110° C. and a weight average molecular weight of from 70,000 to 600,000. The glass transition temperature is more preferably 75° C. or higher and 105° C. or lower. The weight average molecular weight is more preferably 120,000 or higher and 300,000 or lower. Here, the glass transition temperature may be measured with a differential scanning calorimeter usually in a nitrogen atmosphere at a heating rate of 10° C./min. The weight average molecular weight may be measured by gel permeation chromatography (GPC).

When the glass transition temperature is too low, the desirable surface hardness may not be attained. When the weight average molecular weight is too low, the melt viscosity of the polymer becomes so low that the molding processability to form a film is deteriorated and also the moldability is deteriorated when the matte film is used in the simultaneous injection molding-lamination method. Accordingly, the precise thickness of the film or the surface matting property may not be obtained. When the weight average molecular weight is too high, the melt viscosity of the polymer becomes so high that the moldability for forming a film is deteriorated and also gel-like materials are generated in the obtained film, and therefore some problems tend to easily arise. While acrylic resins usually have a glass transition temperature of about 30° C. to 110° C., acrylic resins having a glass transition temperature of from 60° C. to 110° C. are properly selected for use in the present invention. Since the glass transition temperature of the acrylic resin is substantially determined in accordance with the composition of monomers composing the resin, the monomer composition may be adjusted such that the glass transition temperature is set within the above range.

As the polymer comprising an alkyl methacrylate, a polymer prepared by copolymerization may be used alone, or a mixture of two or more polymers having different weight average molecular weights may be used. In particular, when it is desired to increase the surface hardness of the film, a mixture containing at least one polymer component having a weight average molecular weight of 70,000 to 200,000 may be used. Furthermore, when it is desired to improve both the surface hardness and the moldability such as suppressing the generation of unevenness during thermoforming after the film formation, it is advantageous to use a mixture containing at least one polymer component having a weight average molecular weight of from 70,000 to 200,000 and at least one polymer component having a weight average molecular weight of from 150,000 to 700,000. The chart of the weight average molecular weight of such a mixture measured by GPC shows a peak spreading towards its foot or a peak having a shoulder. Preferably, the polymer component having a weight average molecular weight of from 70,000 to 200,000 has a glass transition temperature of about 90° C. to 110° C., and the polymer component having a weight average molecular weight of from 150,000 to 700,000 has a glass transition temperature of about 40° C. to 80° C.

Acrylic rubber particles may comprise a rubber elastic material prepared by copolymerizing an alkyl acrylate having 4 to 8 carbon atoms in its alkyl moiety, a polyfunctional monomer and optionally other monofunctional monomer. In addition to the acrylic rubber particles having a monolayer structure of such a copolymer, acrylic rubber particles having a multilayer structure containing such a copolymer in one layer may also be used. The polyfunctional monomer used herein may be a compound having at least two polymerizable carbon-carbon double bonds in a molecule and examples thereof include alkenyl esters of unsaturated carboxylic acids such as allyl (meth)acrylate and methallyl (meth)acrylate; dialkenyl esters of dibasic acids such as diallyl maleate; and diesters of glycols with unsaturated carboxylic acids such as alkylene glycol di(meth)acrylate; and the like. Examples of the other monofunctional monomers used as an optional copolymer component include styrene, nuclear alkyl-substituted styrene, α-methylstyrene, acrylonitrile, etc.

The acrylic rubber particles having a multilayer structure containing a rubber elastic material, which are prepared by copolymerizing a monomer mixture comprising an alkyl acrylate and a polyfunctional monomer, are particles having a layer of the rubber elastic material including the copolymer of, for example, the alkyl acrylate and the polyfunctional monomer, and a hard layer formed of a polymer comprising methyl methacrylate which is formed around the layer of the rubber elastic material. The acrylic rubber particles having a multilayer structure may have two, three or more layers. Examples of acrylic rubber particles having a two-layer structure include those having an inner layer formed of a rubber elastic material prepared by copolymerizing a monomer mixture containing essentially the alkyl acrylate and the polyfunctional monomer, and an outer layer formed of a hard polymer comprising methyl methacrylate. Examples of acrylic rubber particles having a three-layer structure include those having an innermost layer formed of a hard polymer comprising methyl methacrylate, an intermediate layer formed of a rubber elastic material prepared by copolymerizing a monomer mixture containing essentially the alkyl acrylate and the polyfunctional monomer, and an outermost layer formed of a hard polymer comprising methyl methacrylate. The innermost layer is preferably crosslinked using a small amount of a polyfunctional monomer besides methyl methacrylate. Such acrylic rubber particles having a three-layer structure may be produced, for example, by a method described in, for example, U.S. Pat. No. 3,793,402, the disclosure of which is hereby incorporated by reference. In the present invention, rubber particles having a multilayer structure of at least two layers are preferably used. More preferably, rubber particles having a three-layer structure is used from the viewpoint of the improvement of the surface hardness of a film.

The average particle size of the acrylic rubber particles is usually about 50 to 500 nm, preferably about 80 nm or more, and more preferably about 150 nm or more. It is preferably about 350 nm or less and more preferably about 300 nm or less. When the average particle size is too small, the impact resistance of a film to be produced tends to deteriorate, while when it is too large, the transparency of the film tends to decrease.

When the acrylic rubber particles, in which the outermost layer is formed of a hard polymer of a monomer comprising methyl methacrylate and a rubber elastic material is surrounded by the outermost layer, are mixed with the matrix resin, the outermost layer of the rubber particles immingles with the matrix resin. Thus, when the rubber component is dyed with ruthenium oxide on the cross-sectional surface of the mixture and observed with an electron microscope, each rubber particle is observed as if the outermost layer is eliminated. Specifically, in the case of acrylic rubber particles having a two-layer structure which consists of an inner layer formed of the rubber elastic material and an outer layer formed of the hard polymer comprising methyl methacrylate, the rubber elastic material portion, that is, the inner layer, is dyed and observed as if the particles have a single layer structure. In the case of acrylic rubber particles having a three-layer structure which consists of an innermost layer formed of the hard polymer comprising methyl methacrylate, an intermediate layer formed of the rubber elastic material and an outermost layer formed of the hard polymer comprising methyl methacrylate, the center part of the particles, that is, the innermost layers, is not dyed and only the rubber elastic material portion, that is, the intermediate layer is dyed and observed as if particles have a two-layer structure. Herein, the average diameter of the rubber particles means a number average value of the diameters of the portions dyed which are observed as a substantially circular shape when the rubber particles are mixed with the matrix resin and the cross-sectional surface of the mixture is dyed with ruthenium oxide.

The polymer comprising an alkyl methacrylate and the acrylic rubber particles preferably comprises about 95 to 40% by weight of an alkyl methacrylate about 5 to 60% by weight of acrylic rubber particles, provided that the total amount is 100% by weight. When the amount of the acrylic rubber particles is too low, it becomes difficult to mold a composition into a film. When it is too high, the surface hardness of the film decreases. The amount of the acrylic rubber particles is more preferable about 10 parts by weight or more based on 100 parts by weight of the total amount of the polymer comprising an alkyl methacrylate and the particles. Even more preferably, the amount of the acrylic rubber particles is 15 parts by weight or more in view of the effective prevention of the film breakage during a printing process or a simultaneous injection molding-lamination process. Furthermore, the resin composition composing the film substrate may contain other polymer component in an arbitrary amount insofar as the effects of the present invention are not impaired.

The film substrate 1 may contain generally used additives. Examples of the additives include weathering stabilizers such as hindered phenol antioxidants, phosphorus antioxidants, sulfur antioxidants, UV absorbers and hindered amine photostabilizers, flame retardants, coloring agents, pigments, inorganic fillers, etc. In a case where, for example, the film substrate formed of the above resin composition, these additives may be added during a step of kneading the polymer comprising an alkyl methacrylate and the acrylic rubber particles, or may be previously compounded in the polymer comprising an alkyl methacrylate and/or the acrylic rubber particles.

In particular, the addition of an UV absorber is preferable because a laminate molded article with improved excellent weather resistance can be obtained. As the UV absorber, for example, benzotriazole UV absorbers and benzophenone UV absorbers may be used singly or as a mixture of two or more of them. Specific examples of the benzotriazole UV absorbers includeL 2,2′-methylenebis[6-(2H-benzotriazol-2-yl)-4-(1,1,3,3-tetramethylbutyl)-phenol], 2-(2-hydroxy-5-methylphenyl)-2H-benzotriazole, 2-[2-hydroxy-3,5-bis(α,α-dimethylbenzyl)phenyl]-2H-benzotriazole, 2-(3,5-di-tert-butyl-2-hydroxyphenyl)-2H-benzotriazole, 2-(3-tert-butyl-2-hydroxy-5-methylphenyl)-5-chloro-2H-benzotriazole, 2-(3,5-di-tert-butyl-2-hydroxyphenyl)-5-chloro-2H-benzotriazole, 2-(3,5-di-tert-amyl-2-hydroxyphenyl)-2H-benzotriazole, 2-(2-hydroxy-5-tert-octylphenyl)-2H-benzotriazole, 2-[2-hydroxy-3-(3,4,5,6-tetrahydrophthalimidomethyl)-5-methylphenyl]-2H-benzotriazole, etc. Specific examples of the benzophenone UV absorbers include 2-hydroxy-4-methoxybenzophenone, 2-hydroxy-4-octoxybenzophenone, 2,4-dihydroxybenzophenone, 2-hydroxy-4-methoxy-4′-chlorobenzophenone, 2,2′-dihydroxy-4-methoxybenzophenone, 2,2′-dihydroxy-4,4′-dimethoxybenzophenone, etc. Among them, benzotriazole UV absorbers with a high molecular weight such as 2,2′-methylenebis[6-(2H-benzotriazol-2-yl)-4-(1,1,3,3-tetramethylbutyl)-phenol)] are preferable, from the viewpoint of the decrease of the volatile components from the film and the prevention of deterioration of printed patterns.

The film substrate 1 is preferably produced by kneading the resin composing the film and additives optionally compounded, followed by fi formation by, for example, extrusion casting using chill rolls or inflation extrusion molding. From the viewpoint of the printability and thickness accuracy, it is preferable to employ an extrusion molding method for forming a film by bringing both surfaces of the film into contact with roll surfaces, or a belt cooling extrusion method for forming a film by bringing both surfaces of the film into contact with metal belts.

A matte resin film 10 can be produced by forming the matte layer 5 on at least one surface of the substrate film 1 produced as described above so that the above-described optical properties are satisfied. The matte layer 5 preferably includes a layer comprising a transparent resin and transparent fine particles dispersed therein.

The transparent fine particles preferably have a refractive index difference (|Nd−Nb|) between the refractive index Nd of the transparent fine particles and the refractive index Nb of the transparent resin in a rage of 0.02 or less, more preferably in a rang of 0.01 or less, further preferably in a rage of 0.005 or less. If the refractive index difference |Nd−Nb| is too large, haze tends to increase, so that the equation: H(%)<1400/Gs(%) may not be satisfied.

The volume average particle size of the transparent fine particles is preferably from 3 to 10 μm, more preferably from 4 to 9 μm, and further preferably from 4.5 to 8 μm. If the volume average particle size is too small, the thickness of the matte layer should be made thinner or the amount of the transparent fine particles in the matte layer should be increased, depending on the particle size, and the strength of the matte layer cannot be maintained. If the volume average particle size is too large, the thickness of the matte layer should be made thicker depending on the particle size, which is not economical, and the matte layer has scabrous matte appearance. As the transparent fine particles, for example, talc, glass beads, silicone particles, etc. as well as crosslinked acrylic or styrene particles may be used. Among them, crosslinked acrylic particles are preferably used in view of easy control of the refractive index and particle size.

Examples of the transparent resin include such as acrylic resins, epoxy resins, ester resins, urethaneacrylate resins, urethane cellulose resins and silicone acrylate resins. Among them, urethaneacrylate resins and urethane cellulose resins are preferably used in view of followability to the elongation or stretching of the film substrate.

The matte layer 5 may be formed by applying a coating composition comprising a transparent resin or a raw material thereof (e.g., a polymerizable monomer or oligomer which is polymerized to form a transparent resin) and transparent fine particles on at least one surface of a substrate film 1, and then optionally drying and/or curing the applied coating composition. For example, the coating composition, which comprises the transparent fine particles dispersed in a solution of the transparent resin or the raw material thereof dissolved in a solvent, is applied on the surface of the film substrate 1 on which the matte layer will be formed, the applied coating composition is dried to evaporated the solvent off and then the coating composition is optionally cured with heat or light when the raw material of the transparent resin is used as a component of the coating composition. The coating composition may be applied by any known method such as die coating, gravure coating, roll coating, blade coating, dip coating, flow coating, and so on. In this case, the matte resin film 10 with the predetermined optical properties as described above can be obtained by adjusting the composition of the paint or the thickness of each of the coating film and the matte layer 5.

The matte resin film 10 may be produced by co-extruding the resin or its composition constituting the substrate film 1 and the resin composition comprising the transparent resin and the transparent fine particles which constitute the matte layer 5 to form a multilayer film. For example, the both resin materials are molten with respective extruders, co-extruded to laminate them by a feed block method or a multimanifold method, the resin melts in the form of a multilayer film are then contacted to rolls or belts to cool and shape them, whereby, the matte resin film 10 comprising the substrate film 10 and the matte layer 5 formed on at least one surface of the substrate film 10 is obtained.

In this case, the number of the rolls or the belts, the arrangement thereof and the materials thereof are arbitrarily selected. However, the following method is preferable in which the resin melts are allowed to pass through a gap between two metal rolls or between a metal roll and a metal belt to contact the resin melts to the metal roll and/or the metal belt, so as to transfer a pattern carved on the surface of the roll or the belt to the surface of the resin film formed. This method is preferable because the profile accuracy of the surface of the film is improved to enhance the decorative property of the film. Alternatively, the surface of a rigid metal roll and the surface of an elastic metal roll are allowed to contact to the respective surfaces of the co-extruded resin melts. This method is advantageous to reduce the strain of the resulting film during the molding and to reduce anisotropy in strength and thermal shrinkage of the film. For example, the elastic metal roll comprises a shaft roll and a cylindrical metallic thin layer which is arranged to cover the outer circumference of the shaft roll and to which the resin melt contacts, wherein a fluid such as water or an oil, the temperature of which is controlled, is sealed between the shaft roll and the metallic thin layer, or the elastic metal roll comprises a rubber roll the surface of which is wrapped with a metal belt.

When the resin melts are sandwiched between the elastic metal roll and the rigid metal roll, the elastic metal roll elastically deforms in a concave shape along the peripheral surface of the rigid metal roll through the resin melts. Thereby, the rigid metal roll and the elastic metal roll compress the resin melts with plane contact and thus the resin melts sandwiched between those rolls are uniformly compressed in a plane form. When the laminated resin melts are shaped with contacting the resin melt for the matte layer to the elastic metal roll, it is possible to suppress the transparent fine particles being put in the transparent resin. Thus, the deterioration of the matte appearance of the matte layer is prevented, and the matte resin film having a desired matte appearance is obtained.

For example, the resin melts extruded through a die are cooled by sandwiching them between an elastic metal roll as the first cooling roll and a rigid metal roll as the second cooling roll, then between the second cooling roll and the third cooling roll while wrapping the resin melts around the second cooling roll. In this case, the forth and/or subsequent cooling roll(s) may optionally be used. In such a cooling process, the matte layer is contacted to the first cooling roll between the first cooling roll and the second cooling roll and then cooled on the periphery of the second cooling roll. Thereafter, the laminate of the resin melts passes a gap between the second cooling roll and the third cooling roll which are not contacted each other unlike the conventional co-extrusion process. Preferably, the gap between he second cooling roll and the third cooling roll is maintained slightly larger than the total thickness of the film to be formed. Since the matte layer is quickly cooled on the periphery of the second cooling roll, more transparent fine particles protrude above the surface of the matte layer because of the difference of the thermal shrinkage factor between the transparent resin and the transparent fine particles. Since no linear pressure is applied to the film between the second cooling roll and the third cooling roll, the protruded transparent fine particles are not pushed back so that the surface of the matte layer has moderate unevenness.

The thickness of the matte layer 5 is preferably from 0.4 to 1.0 time, more preferably from 0.5 to 0.9 time, the volume average particle size of the transparent fine particles, particularly when the matte layer 5 is formed by the application of the coating composition as described above. When the thickness of the matte layer is within this range, the transparent fine particles moderately protrude above the surface of the matte layer and exhibit an excellent matting effect even if viewed at any angle. Moreover, most of the transparent fine particles may protrude to only a spherical upper half above the surface of the matte layer so that moderate unevenness is formed on the surface of the matte layer, thereby to impart good matting performance as well as high transparency, that is, a matte resin film with low haze for the less gloss may be produced. If the thickness of the matte layer is 0.4 time the volume average particle size of the transparent fine particles, most of the transparent fine particles will protrude to the portion below the spherical equator above the surface of the matte layer, and haze easily increases in spite of the gloss not being lowered sufficiently because a part of incidence light is strongly scattered by such transparent fine particles. If the thickness of the matte layer exceeds 1.0 time the volume average particle size of the transparent fine particles, most of the transparent fine particles are buried in the matte layer due to settling of the transparent fine particles in the coated film of the coating composition during the application step, shininess tends to be observed due to insufficient diffusion of a reflected light in a case where an angle between the matte surface and a direction observing the reflected light is small.

The whole thickness of the matte acrylic resin film 10 thus produced is preferably about 40 to 800 μm, more preferably about 50 to 500 μm. When the matte layer 5 is formed only on one surface of the matte film 10, a pattern may be printed on the other surface 7 of the matte film 10, or the film substrate 1 itself may be colored to impart the designability. When the matte layers 5 are formed on both surfaces of the matte film 10, the film substrate 1 itself may also be colored to impart the designability. The matte resin film 10 is desirable from the viewpoint of the retention of the matting performance upon molding since it has excellent molding processability, and thus it is preferably used in a surface coating method including a simultaneous injection molding-lamination method.

Furthermore, the matte resin film 10 may have a pressure-sensitive adhesive layer or an adhesive layer on one surface thereof. Such a layer may be readily formed by coating a pressure-sensitive adhesive or an adhesive to the desired surface of the film. When the matte layer 5 is formed on one surface of the film substrate 1, the pressure-sensitive adhesive layer or the adhesive layer may be formed on the surface on which the matte layer 5 is formed or on the opposite surface which is an unmatted smooth surface 7. When the matte layer 5 is formed on one surface, in general, the pressure-sensitive adhesive layer or the adhesive layer is advantageously formed on the opposite surface 7.

In the case of a film having the matte layer 5 only on one surface, when a pattern is printed on the surface 7 having no matte layer, the printing is carried out by, for example, gravure printing, screen printing or printing using an ink jet printer which utilizes a computer graphic technology by making the best use of the feature that the surface 7 is smooth. When the printing is applied on the smooth surface 7 having no matte layer, a pressure-sensitive adhesive layer may be formed on the printed layer so that such a film can be used as a marking film.

A marking film means a film on which patterns such as various kinds of letters, symbols and photographs are printed and which is adhered to the surfaces of various structural objects. The marking film may be used for such as advertisements, propagandas, warnings and displays and thus usable for, for example, outdoor advertisement boards, guiding signs (such as signs in stations), markings for various kinds of vehicles such as passenger vehicles, trucks, buses, railway cars (such as electric trains and passenger cars), markings for automatic vending machines, markings for wooden walls of factories and construction sites, markings for shutters and outer walls, markings for construction machineries, markings for ships, and decorative displays for in-line members of passenger vehicles, trucks, bicycles and light electrical parts. While flexible vinyl chloride resin films, polyurethane resin films and polyethylene terephthalate films have been conventionally used as marking films, when the resin film used as a substrate is formed of the acrylic resin film according to the present invention, it has excellent weather resistance and light fastness in comparison with the conventional marking films.

The matte film of the present invention can be used in the form of a multilayer film or sheet by laminating the matte film on other film or sheet. In this case, the matte film and the other film or sheet are laminated so that the matte layer 5 forms the front surface of the multilayer film or sheet. When the matte layer 5 is formed on one surface of the film substrate 1, the other film or sheet may be laminated on the surface 7 opposite to the matte layer 5. When the matte layers 5 are formed on both surfaces of the film substrate 1, the other film or sheet may be laminated on either one surface of the matte film. Examples of the resin composing the other film or sheet include such as acrylic resins, flexible vinyl chloride resins, polyurethane resins, polyester resins such as polyethylene terephthalate, and polyolefin resins. A pattern may be printed on the surface of the other film or sheet. In the case of making a multilayer film or sheet, for example, a so-called lamination method such as a method comprising molding a thermoplastic resin in the form of a film or a sheet in advance and then continuously laminating the obtained film or sheet and the matte film of the present invention by passing them between heat rolls, a method comprising thermally bonding the other film or sheet and the matte film of the present invention with a press, or a wet lamination method comprising inserting an adhesive layer between the other film or sheet and the matte film of the present invention, can be employed.

Such a multilayer film may also be used as a marking film by forming a pressure-sensitive adhesive layer on the opposite surface of the laminated matte film. When the multilayer film is used as the marking film, the matte layer 5 is formed on one surface of the film substrate 1 to constitute the matte film 10 of the present invention and then a pattern may be printed on the surface 7 opposite to the matte layer 5, or a pattern may be printed on the other film to be adhered to the matte film 10, or a pattern may be printed on the opposite side of the surface of the other film to which the matte film 10 is adhered.

Furthermore, the matte film, the matte film having the matte layer on one surface and the printed pattern on the other surface, or the multilayer film or sheet including the matte film which is laminated on the other film or sheet in such a manner that the matte layer forms the front surface according to the present invention may be integrally laminated on the surface of a thermoplastic resin molded article by, for example, a simultaneous injection molding-lamination method. In any case, lamination is usually carried out in a manner such that the matte layer of the matte film is present on the outermost side. Examples of the thermoplastic resin suitable for laminating the matte film or multilayer film or sheet having the matte film of the present invention include polyolefin resins, vinyl chloride resins, acrylonitrile-butadiene-styrene copolymers (ABS resin), polyurethane resins and acrylic resins.

The simultaneous injection molding-lamination method may be carried out by a method comprising inserting the above film or sheet, which has not been pre-molded, into an injection mold, injecting a resin melt therein, and forming an injection molded article with simultaneously laminating the film or sheet on the molded article (sometimes referred to as a narrowly-defined simultaneous injection molding-lamination method); a method comprising firstly pre-molding the above film or sheet by vacuum molding or pressure forming, inserting the pre-molded resin film into an injection mold, injecting a resin melt therein, and forming an injection molded article with simultaneously laminating the film or sheet on the molded article (sometimes referred to as an insert molding method); a method comprising firstly pre-molding the above film or sheet by vacuum molding or pressure forming in an injection mold, injecting a resin melt in the mold, and forming an injection molded article with simultaneously laminating the film or sheet on the molded article (sometimes referred to as an in-mold method); or the like. The details of the simultaneous injection molding-lamination method are found in JP-B-63-6339, JP-B-4-9647 and JP-A-7-9484.

### EXAMPLE

Hereinafter, the present invention will be described in more detail by making reference to the Examples, which do not limit the scope of the present invention in any way. In the examples, “parts” expressing the amounts are “parts by weight” unless otherwise specified.

Acrylic Resin

As a methacrylic resin, a resin was used, which was produced by bulk polymerizing a monomer mixture of 99% by weight of methyl methacrylate and 1% by weight of methyl acrylate and having a glass transition temperature of 105° C., a weight average molecular weight of about 140,000 and a refractive index of 1.49. A glass transition temperature was extrapolated glass transition starting temperature measured at a heating rate of 10° C./min. by differential scanning calorimetry according to JIS K7121. The weight average molecular weight was measured by GPC using three columns arranged in series: TSKgel GMHHR-H (7.8 mmφ×300 mm) (manufactured by Tosoh Corporation) under the following conditions:

Solvent: tetrahydrofuran

### Temperature: 40° C.

### Detector: RI

Flow rate: 1.0 ml/min.
Standard PMMA samples were used as molecular weight standards.

Rubber Particles

Rubber particles used were produced according to Example 3 of U.S. Pat. No. 3,793,402, the disclosure of which is hereby incorporated by reference, and had a spherical three-layer structure including an innermost layer formed of a hard polymer prepared by polymerizing methyl methacrylate and a small amount of allyl methacrylate, an intermediate layer formed of an elastic polymer prepared by polymerizing butyl acrylate as a primary component, styrene and a small amount of allyl methacrylate, and an outermost layer formed of a hard polymer prepared by polymerizing methyl methacrylate and a small amount of ethyl acrylate. The particles had an average particle size of about 210 nm when mixed with a matrix resin.

As the ultraviolet absorber, 2,2′-methylene-bis[6-(2H-benzotriazol-2-yl)-4-(1,1,3,3-tetramethylbutyl)phenol] (ADEKASTAB LA-31 manufactured by ADEKA Corporation) was used.

Crosslinked Particles

The following particles were used as crosslinked particles:

Crosslinked particles (A): MBX-5 (refractive index Nd=1.495, volume average diameter 5.0 μm manufactured by Sekisui Plastics Co., Ltd.)

Crosslinked particles (B): MBX-8 (refractive index Nd=1.495, volume average diameter 7.9 μm manufactured by Sekisui Plastics Co., Ltd.)

Crosslinked particles (C): XX-66K (refractive index Nd=1.495, volume average diameter 2.7 μm manufactured by Sekisui Plastics Co., Ltd.)

Crosslinked particles (D): XX-133K (refractive index Nd=1.525, volume average diameter 5.1 μm manufactured by Sekisui Plastics Co., Ltd.)

Crosslinked particles (E): MBX-5H (refractive index Nd=1.495, volume average diameter 5.1 μm manufactured by Sekisui Plastics Co., Ltd.)

Crosslinked particles (F): XX-219K (refractive index Nd=1.505, volume average diameter 4.0 μm manufactured by Sekisui Plastics Co., Ltd.)

Crosslinked particles (G): XX-24K (refractive index Nd=1.515, volume average diameter 5.3 μm manufactured by Sekisui Plastics Co., Ltd.)

### Examples 1-7 and Comparative Examples 1-9

Eighty parts of the methacrylic resin, 20 parts of the rubber particles, and 0.5 part of the ultraviolet absorber were mixed with a tumbler mixer and melt-kneaded with a unidirectional rotation type twin screw extruder while keeping the temperature of the resin at 255° C. and then pelletized. Next, the pellets of the methacrylic resin composition were extruded through a T type film die (lip clearance: 0.5 mm; width: 600 mm width; preset temperature: 250° C.) using a single screw extruder (barrel diameter 65 mmφ; manufactured by Toshiba Machine Co., Ltd.) while bringing both surfaces of the film in complete contact with cooling polishing rolls to obtain an acrylic resin film having a thickness of 75 μm.

Formation of Matte Layer

Eighteen parts of crosslinked particles shown in Table 1, 55 parts Of a paint containing acrylpolyol [Topcoat PTC-NT-U-605 Medium (A1) manufactured by Dainichiseika Color & Chemicals Mfg. Co., Ltd.] and 27 parts of a solvent (PTC-NT No. 2 manufactured by Dainichiseika Color & Chemicals Mfg. Co., Ltd.) were mixed to prepare a dispersion of transparent fine particles. This dispersion of transparent fine particles (abbreviated as “dispersion” in Table 1), a paint containing acrylpolyol (the same as above; abbreviated as “paint” in Table 1), an isocyanate curing agent [Topcoat No. 73 manufactured by Dainichiseika Color & Chemicals Mfg. Co., Ltd.; abbreviated as “curing agent” in Table 1], and a solvent (the same as above) were mixed at a weight ratio shown in Table 1, and this paint was applied onto one surface of the acrylic resin film produced above with a bar coater shown in Table 1. After that, the film was allowed to stand in an oven at 60° C. for 2 hours for drying and curing, thereby to obtain a matte resin film having a matte layer on one surface.

Measurement of Refractive Index of Transparent Resin for Matte Layer

Ten parts of a paint containing acrylpolyol (the same as above) was mixed with 1 part of an isocyanate curing agent (the same as above). The mixture was applied onto a glass substrate, and the glass plate was allowed to stand in an oven at 60° C. for 2 hours for drying and curing to obtain a transparent resin. When a cut piece of the transparent resin was dipped in a standard solution having a refractive index of 1.496 and observed with an optical microscope, the outline of the section was disappeared. In a case where standard solutions having a respective refractive index of 1.492 and 1.500 were used, the outline of the section was confirmed. Based on the above observations, the refractive index Nb of the transparent resin in the matte layer was confirmed to be 1.496±0.002.

With respect to the resulting matte resin films, a haze H, a 60 degree specular gloss Gs and a 85 degree specular gloss Gs′ on a matte surface, and a thickness of a matter layer were measured by the following methods. These results were shown in Table 1.

Haze Value H

A haze value H was measured according to JIS K7136 using HR-100 (manufactured by Murakami Color Research Laboratory) with while the matte surface being faced to the light source side.

60 Degree Specular Gloss Gs and 85 Degree Specular Gloss Gs′

A 60 degree specular gloss Gs and a 85 degree specular gloss Gs′ on the matte surface were measured according to ASTM D523 using a gloss meter GM-268 (manufactured by Konicainolta Holdings Inc.).

Thickness of Matte Layer

The shortest distance from the boundary of a matte layer and a substrate film layer (acrylic resin film layer) to the surface of the matte layer was measured with a field emission scanning electron microscope FE-SEM S-4200 (manufactured by Hitachi Ltd.), and this distance was used as the thickness of the matte layer.

TABLE 1

| | | | | | Curing | | | | | | | Ratio of |
|---|---|---|---|---|---|---|---|---|---|---|---|---|
| Example | Crosslinked | Bar | Dispersion | Paint | agent | Solvent | Gs | Gs′ | H | 1400/ | Thickness | Thickness to |
| No. | particles | coater | (parts) | (parts) | (parts) | (parts) | (%) | (%) | (%) | Gs (%) | (μm) | Particle diameter |
| Example 1 | (A) | #6 | 4 | 6 | 1 | 2 | 19.4 | 10.4 | 54.1 | 72.2 | 4.5 | 0.90 |
| Example 2 | (A) | #6 | 3 | 7 | 1 | 2 | 27.1 | 17.1 | 40.7 | 51.7 | 4.5 | 0.90 |
| Example 3 | (A) | #6 | 2 | 8 | 1 | 2 | 42.3 | 28.5 | 28.2 | 33.1 | 4.4 | 0.88 |
| Example 4 | (A) | #6 | 1.5 | 8.5 | 1 | 2 | 55 | 41.1 | 21 | 25.5 | 4.5 | 0.90 |
| Example 5 | (B) | #6 | 4 | 6 | 1 | 2 | 20.4 | 6.8 | 55.2 | 68.6 | 4.6 | 0.58 |
| Example 6 | (B) | #6 | 2 | 8 | 1 | 2 | 42.5 | 22.8 | 27.9 | 32.9 | 4.5 | 0.57 |
| Example 7 | (B) | #6 | 1.5 | 8.5 | 1 | 2 | 55 | 32.4 | 21.3 | 25.2 | 4.6 | 0.58 |
| C. Ex. 1 | (C) | #6 | 8 | 2 | 1 | 2 | 25.6 | 46.9 | 33.5 | 54.7 | 4.3 | 1.59 |
| C. Ex. 2 | (C) | #6 | 6 | 4 | 1 | 2 | 38.2 | 59.8 | 21.3 | 36.6 | 4.4 | 1.63 |
| C. Ex. 3 | (C) | #6 | 4 | 6 | 1 | 2 | 59.7 | 80 | 10.8 | 23.5 | 4.4 | 1.63 |
| C. Ex. 4 | (A) | #3 | 6 | 4 | 1 | 2 | 16.3 | 10.8 | 87.4 | 85.9 | 1.8 | 0.36 |
| C. Ex. 5 | (A) | #3 | 4 | 6 | 1 | 2 | 19.8 | 12.6 | 74.3 | 70.7 | 1.9 | 0.38 |
| C. Ex. 6 | (A) | #3 | 2 | 8 | 1 | 2 | 31.5 | 15.4 | 49.5 | 44.4 | 1.9 | 0.38 |
| C. Ex. 7 | (A) | #8 | 8 | 2 | 1 | 2 | 23.2 | 27 | 40.9 | 60.3 | 5.8 | 1.16 |
| C. Ex. 8 | (A) | #8 | 6 | 4 | 1 | 2 | 28.6 | 41.3 | 29 | 49 | 5.5 | 1.10 |
| C. Ex. 9 | (A) | #8 | 4 | 6 | 1 | 2 | 36.6 | 50.8 | 22.1 | 38.3 | 5.4 | 18 |
| C. Ex. 10 | (D) | #6 | 3 | 7 | 1 | 2 | 23 | 13.7 | 63.6 | 60.9 | 4.6 | 0.90 |
| C. Ex. 11 | (D) | #6 | 2 | 8 | 1 | 2 | 33.8 | 22.8 | 45.8 | 41.1 | 4.5 | 0.88 |
| C. Ex. 12 | (D) | #6 | 1.5 | 8.5 | 1 | 2 | 44 | 32.9 | 34.1 | 31.8 | 4.5 | 0.88 |

A matte black paint (Mr. COLOR 33 manufactured by GSI Creos Corporation) was applied onto the surface opposite to the matte surface of each of the matte resin films produced in the above, and the black paint was observed with an eye from the side of the matte surface. When the films having a close 60 degree specular gloss Gs were mutually compared, clear black color with less whiteness was observed with the films of Examples 1 and 5 as compared to that of Comparative Example 5. Further, clear black color with less whiteness was observed with the film of Example 2 as compared to that of Comparative Example 6. Moreover, in the case of comparisons between Example 1 and Comparative Example 10, between Example 2 and Comparison Example 11 and between Example 3 and Comparison Example 12, clear black color with less whiteness was observed in each of Examples 1 to 3 in spite of the smaller Gs.

Further, with the matte resin films produced in the above, shininess of the matte surface was observed with an eye at a viewing angle in the rage of 5 degrees to 10 degrees from the matte surface under a fluorescent light. When the films having a close 60 degree specular gloss Gs were mutually compared, the film of Example 2 showed less shininess than those of Comparative Examples 1 and 8, and the films of Examples 3 and 6 showed less shininess than those of Comparative Examples 2 and 9.

### Examples 8-10 and Comparative Examples 13-16

Seventy parts of the methacrylic resin and 30 parts of the rubber particles were mixed with a SUPER MIXER. Then, the mixture was melt-kneaded and extruded with a twin-screw extruder to prepare pellets of a resin composition for a substrate film layer (acrylic resin film layer). Separately, the methacrylic resin, the rubber particles and crosslinked particles shown in Table 2 were mixed in the amounts shown in Table 2 with a SUPER MIXER. Then, the mixture was melt-kneaded and extruded with a twin-screw extruder to prepare pellets of a resin composition for a matte layer.

Then, the pellets of the resin composition for a substrate film layer were molten in a 65 mmφ single screw extruder (manufactured by Toshiba Machine Co., Ltd.), and the pellets of the resin composition for a matte layer were molten in a 45 mmφ single screw extruder (manufactured by Toshiba Machine Co., Ltd.). The respective resin melts were laminated on and integrated each other by a feed block method, and the integrated laminate was extruded through a T-die set at 265° C. to obtain a film-form material. This film-form material was shaped by passing it through a cooling unit comprising an elastic metal roll as the first cooling roll and two rigid metal rolls as the second and third cooling rolls to obtain a matte resin film having a two-layer structure which consisted of a substrate film layer with a thickness of 65 μm and a matte layer with a thickness of 10 μm. In this case, the pin of a feed block was adjusted so that the matte layer side was contacted to the first cooling roll. In the cooling steps, the film was passed through the gap between the first and second cooling rolls with contacting the surfaces of the film to the rolls, while it was passed through the gap between the second and third cooling rolls without contacting the second and third cooling rolls to each other with leaving a space of 0.5 mm between them.

With regard to the matte resin film produced in the above, a haze H, and a 60 degree specular gloss Gs and a 85 degree specular gloss Gs′ on a matte surface were measured by the same methods as described above, and 1400/Gs (%) was calculated. The results are shown in Table 2.

TABLE 2

| | Meth- | Rubber | | | | | | |
|---|---|---|---|---|---|---|---|---|
| | acrylic | parti- | Crosslinked | | | | | 1400/ |
| Example | resin | cles | particles | | Gs | Gs′ | H | Gs |
| No. | (parts) | (parts) | kind | parts | (%) | (%) | (%) | (%) |
| Ex. 8 | 77.5 | 20 | (E) | 2.5 | 88.2 | 73.5 | 10.1 | 15.9 |
| Ex. 9 | 73 | 20 | (E) | 7 | 43.9 | 42.8 | 24.6 | 31.9 |
| Ex. 10 | 65 | 20 | (E) | 15 | 19.6 | 18.3 | 47.0 | 71.4 |
| Ex. 11 | 50 | 20 | (E) | 30 | 10.5 | 7.5 | 76.0 | 133.3 |
| C. Ex. 13 | 73 | 20 | (F) | 7 | 31.4 | 28.9 | 48.5 | 44.6 |
| C. Ex. 14 | 65 | 20 | (F) | 15 | 16.4 | 15.4 | 87.6 | 85.4 |
| C. Ex. 15 | 73 | 20 | (G) | 7 | 24.1 | 26.3 | 69.9 | 58.1 |
| C. Ex. 16 | 65 | 20 | (G) | 15 | 15.2 | 17.9 | 95.1 | 92.1 |

A matte black paint (Mr. COLOR 33 manufactured by GSI Creos Corporation) was applied onto the surface opposite to the matte surface of each of the matte resin films produced in the above, and the black paint was observed with an eye from the side of the matte surface. When the films having a close 60 degree specular gloss Gs were mutually compared, clear black color with less whiteness was observed with the film of Example 10 as compared to that of Comparative Example 15. Further, clear black color with less whiteness was observed with the film of Example 11 as compared to those of Comparative Examples 14 and 16 in spite of the smaller Gs.

What is claimed is:

1. A matte resin film comprising a resin film substrate and a matte layer formed on at least one surface of the substrate, wherein a 60 degree specular gloss Gs on the surface of the matte layer is 5% to 100%, a haze H satisfies the equation: H(%)<1400/Gs(%), and a 85 degree specular gloss Gs′ on the surface of the matte layer is smaller than Gs.

2. The matte resin film according to claim 1, wherein the 60 degree specular gloss Gs is from 14 to 60%.

3. The matte resin film according to claim 1, wherein the matte layer comprises a transparent resin and transparent fine particles dispersed therein.

4. The matte resin film according to claim 3, wherein the difference (|Nd−Nb|) between a refractive index Nd of the transparent fine particles and a refractive index Nb of the transparent resin is 0.02 or less.

5. The matte resin film according to claim 3, wherein a volume average particle size of the transparent fine particles is from 3 to 10 μm.

6. The matte resin film according to claim 3, wherein a thickness of the matte layer is 0.4 to 1 time the volume average particle size of the transparent fine particles.

7. The matte resin film according to claim 3, wherein the transparent fine particles are crosslinked acrylic particles.

8. The matte resin film according to claim 1, wherein the resin film substrate comprises a resin composition containing a polymer comprising an alkyl methacrylate, and acrylic rubber particles.

9. The matte resin film according to claim 8, wherein the polymer comprising an alkyl methacrylate is at least one polymer selected from the group consisting of a homopolymer of an alkyl methacrylate and a copolymer comprising an alkyl methacrylate and an alkyl acrylate.

10. The matte resin film according to claim 8, wherein the polymer comprising an alkyl methacrylate has a glass transition temperature of from 60° C. to 110° C. and a weight average molecular weight of from 70,000 to 600,000.

11. The matte resin film according to claim 8, wherein the acrylic rubber particles are multilayer structure particles comprising a layer formed of a rubber elastic material comprising a copolymer of an alkyl acrylate having 4 to 8 carbon atoms in its alkyl moiety and a polyfunctional monomer, and a layer formed of a hard polymer comprising methyl methacrylate which is formed around the layer formed of the rubber elastic material.

12. The matte resin film according to claim 8, wherein the acrylic rubber particles have an average particle size of from 50 to 500 nm.

13. The matte resin film according to claim 1, which has a total thickness of from 40 to 800 μm.

14. The matte resin film according to claim 1, wherein the matte layer is formed on one surface of the resin film substrate and a pattern is printed on the other surface of the matte layer.

15. A marking film comprising a matte resin film according to claim 14 and a pressure-sensitive adhesive layer formed on the surface of said matte resin film having a pattern printed thereon.

16. A multilayer film or sheet comprising a matte resin film according to claim 1 one surface of which serves as a front surface of the multilayer film or sheet, and other film or sheet laminated on a surface of the matte resin film opposite to the matte layer.

17. A laminate molded article comprising a molded article of a thermoplastic resin, and a matte resin film according to claim 1 or a multilayer film or sheet according to claim 16 which is laminated on the molded article with the matte layer serving as a front surface of the laminate molded article.
